(19) United States
(12) Patent Application Publication
(10) Pub. No.: US 2003/0023779 A1
(43) Pub. Date: Jan. 30, 2003

(54) Symbol window correlative operation circuit and address generation circuit therefor

(76) Inventors: Hideo Mizutani, Yokohama-shi (JP); Hiroyuki Sakurai, Yokohama-shi (JP); Takuro Sato, Yokohama-shi (JP); Katsumi Tokuyama, Tokyo (JP)

Correspondence Address: ARMSTRONG,WESTERMAN & HATTORI, LLP, 1725 K STREET, NW., SUITE 1000, WASHINGTON, DC, 20006, US

(21) Appl. No.: 10/193,708

(22) Filed: Jul. 12, 2002

(30) Foreign Application Priority Data
Jul. 13, 2001 (JP) 2001-247442

(51) Int. Cl. G06F 3/00

(52) U.S. Cl. 710/11

(57) ABSTRACT

Improvement is obtained in quality of transmitting by extraction of the accurate transfer data from the Symbol data stream includes Guard Interval and transfer data. The first aspect of the present invention is expansion of the size of the memory means for inputting to be able to store N+n samples (N means the size of symbol data, n is smaller than GI) using means to input the discrete input data sampled at a constant period, and fetch N samples of data from the optimum position. In the second aspect, the size of memory block for inputting stores N samples (N is power of 2, and N means the size of symbol data) as not changing their size. For inputting, at least 2 memory blocks are allocated with the function to independently control the riming to initiate fetching the input data to the each block. Therefore the data at the optimum position can be selected at the operation. In the third aspect, an address generation circuit is provided, which comprises a combination of small size ROM and simple logic circuit. It can reduce the memory size of ROM remarkably.

### BACKGROUND OF THE INVENTION

1. Field of the Invention

The present invention relates to a data communication system performed by wireless transmission on OFDM (Orthogonal Frequency Division Multiplex) modulation system such as a high speed wireless LAN and a digital TV broadcast system, more particularly, to a circuit configuration to execute FFT operation and correlative operation of the given particular signal series of the time length (window) signal previously set and fetch from a time series signal using the periodicity of the discrete time series signal given at a constant period and. a circuit configuration of address generation to control FFT operation and IFFT operation for sub-carrier at butterfly operation.

2. Description of the Related Art

In the wireless transmission system, it is used “Fast Fourier Transform circuit” to demodulate the received data. This FFT circuit is comprised by an operation circuit (Data-path) which execute the FFT operation, memory circuits comprised by input memory means (memory block) used to store the input data from input means, a temporary (working) memory of die intermediate data, and a hold memory of the final computed result, a multiplexer circuit to switch output and input of the Data-path and the memory circuits, a state control device to control the operation of state and the operation process of each circuit.

Each of the memory circuits is comprised by multiple single blocks that support each process of the operation, having their capacity (size) to fit the size of length (the number of sampling points) of the data sequence at the FFT operation. It also contains the number of memory blocks required to store the successively input data, for working memory while operating, and to hold/output the final computed result operated in each process. Multiple single memory blocks operate concurrently for a pipeline operation of each process.

As one of the examples of the prior art in the above thought, there is provided in the second embodiment in the laid-open patent publication in Japan 2000-040080, named “First Fourier transform circuit” published on Feb. 8, 2000.

In this example, a “First Fourier transform circuit” operation is executed at the statement of the number of sampling points that is N/4, and the size of each block is N/4 words. It means that the memory block is adopted to store the data of N (real number part and imaginary number part of N sampling points) length of the data sequence with the same length as the sampling point N that is FFT operated.

FIG. 8 shows a circuit configuration diagram, in which a memory circuit is mainly shown for explaining the architecture of the memory block of tile FFT circuit shown in the above publication. In this FFT circuit, there is shown 3 types of memory blocks 31a, 31b, 32a, 32b, 33a and 33b (a means real part and b means imaginary part of the data), which operate a pipeline operation corresponding to the operation process: multiplexer circuits MPX 34, 35, and a Data-path circuit 36.

At the FFT operation in a normal operation, memory blocks 31a and 31b receives and stores the discrete input data of N samples sampled at a constant period from external or front input means. Parallel to the above operation, the memory blocks 32a and 32b supply the discrete data which has been stored in the Data-path 36 at last symbol cycle to the Data-path 36, and receive and store the computed result, or the intermediate result by the operation of the Data-path 36. The memory blocks 33a and 33b receive and transfer the computed result at the last symbol cycle to external (or next block) concurrently with operation of the above memory blocks 31a, 31b, 32a and 32b.

At next symbol cycle, Data-path 36 operates, using the discrete data of N samples stored in memory blocks 31a and 31b at the last symbol cycle. The computed result is input and stored in the memory blocks 32a and 32b, concurrently transferring the stored data of memory blocks 32a and 32b to the memory block 33a and 33b which stores the operating result operated at the last symbol cycle. At the same time, the memory blocks 33a and 33b transfer the discrete data of N samples sampled at a constant period to the external or the rear means concurrently with each operation of the memory blocks 31a, 31b, 37a and 32b

Hereinafter, the above memory blocks 31a, 31b, 32a, 32b, 33a and 33b repeat the series of operation as sequentially rotating each of functions performed at each symbol cycle.

In the conventional technology, address signals for RAM are generally generated by using only a ROM in performing a processing operation of the butterfly type calculation in the FFT operation. However, this circuit for address generation has disadvantage of being not compact so that the size of ROM becomes too large. Another approach is capable of performing a butterfly type computation by using only a logic circuit for address generation. However, this approach is apt to make the circuit very complicated, since sequence of the arrangement of data is required to control FFT circuit for performing a butterfly type computation and it is too complicated by controlling the sequence using only a logic circuit.

FIG. 9 shows a conventional overview of the address generation for a RAM storing data in the FFT operation circuit. Two FFT circuits 1-1, 1-2 are prepared to perform operation of radix 4. Two input data 1-3 are input to each of the FFT circuits for butterfly calculation two times successively for each FFT circuit. Data for inputting to the circuits is stored in the RAM 1-4. ROM 1-5 generates address signal 1-6 for RAM 1-4 for calling data from the RAM to perform the butterfly type computation. Also, ROM 1-5 generates address signal 1-8 for RAM 1-4 for storing the result data 1-7 computed by the FFT circuit. In the conventional address generation circuit for the FFT circuit, the necessary storage capacity of ROM becomes too large since the address is generated in the ROM and addressing circuit becomes complicated.

FIG. 10 shows an overview of an example of a combination of address data in performing a 64-point, radix 4 butterfly computation. The butterfly computing process has 3 stages. In each processing stage, it is used that address data is a+4n (n=0, 1, 2, 3), a+2n (n=0, 1, 2, 3), a+n (n=0, 1, 2, 3). Because two FFT circuits 9-1, 9-2 are provided, the butterfly type computation is performed under a combination of two different address data at a time. To read and store the data, a combination of address data as shown in FIG. 10 is required. The address generated at a time should be maximum 8 addresses and cycles be 129 cycles. Therefore, the size of the circuit become inevitably large. If the address generation is carried out only by a logic circuit, the size of the address generation circuit become too increased for performing regularity of the address generation.

### SUMMARY OF THE INVENTION

In such conventional configuration of symbol window FFT operation circuit as described above, it was difficult; to adaptively control a data position of symbol data having a constant size (sample numbers) in the symbol window for FFT operation, which is (etched from sequentially input data at each symbol cycle; and to immediately reflect the symbol data fetched from adjusted position for next symbol cycle of the FFT operation. That is, it is not possible to shift the timing position of fetching data from sequentially input data in the symbol window, because the data processed at next symbol cycle is in progress in sequentially input data operation at present symbol cycle.

To solve the above problem, according to the present invention, it is possible to improve transmission quality by enabling to control a data position of symbol data, which is fetched from symbol data stream including guard interval (GI) and symbol data. The symbol window adaptive control operation circuit of first aspect of the present invention, is comprised by input memory means (memory block) used to store the discrete sequentially input data formed by sampling at an interval from input means, and the size of the input memory means (symbol window) is expanded to store N+n samples (N is data size of one symbol data and n is a size smaller than a size of guard interval (GI)). Therefore, N sample for FFT operation can be fetched at most preferable position in N+n samples in input memory means.

According to second aspect of the present invention, there is provided a symbol window adaptive control operation circuit, which is comprised by at least 2 blocks of input memory means used to store the discrete sequentially input data formed by sampling at an interval from input means, wherein the size of each of input memory means is not changed for storing N samples (N is data size of one symbol data) as it is. Giving a function that each of at least 2 blocks of input memory means can be independently fetched for FFT operation, the data of preferable block can be fetched for FFT operation thus improving transmission quality.

According to another aspect of the present invention, there is provided an address generation circuit for FFT operation circuit. The address generation circuit is comprised by a combination of ROM and logic circuit, which is able to minimize the size of the address generation circuit.

The above and other objects, features, and advantages of the present invention will be apparent from the following description when taken in conjunction with the accompanying drawings which illustrates preferred embodiments of the present invention by way of example.

It should be noted that elements, sizes, shapes and locations are roughly illustrated for showing just examples.

### BRIEF DESCRIPTION OF THE DRAWINGS

FIG. 1 is a functional block diagram of the operation circuit with an access timing adaptive control according to the first embodiment of the present invention;

FIG. 2 is a time chart of the operation circuit with an access timing adaptive control according to the first embodiment of the present invention;

FIG. 3 is a functional block diagram of the operation circuit with an access timing adaptive control according to the second embodiment of the present invention;

FIG. 4 is a time chart of the operation circuit with an access timing adaptive control according to the second embodiment of the present invention;

FIG. 5 is a functional block diagram of the address generation circuit for the FFT circuit according to the present invention;

FIG. 6 is a block diagram showing a configuration of the address generation circuit for the FFT circuit according to the first embodiment of the present invention;

FIG. 7 is a block diagram showing a configuration of the address generation circuit (or the FFT circuit according to the second embodiment of the present invention;

FIG. 8 is a functional block diagram of the conventional operation circuit without an access timing adaptive control for the symbol window;

FIG. 9 is a functional block diagram of the conventional address generation circuit for the FFT circuit; and

FIG. 10 is a chart showing an example of a combination of address data for performing a butterfly type computation.

### DETAILED DESCRIPTION OF THE PREFFERED EMBODIMENTS

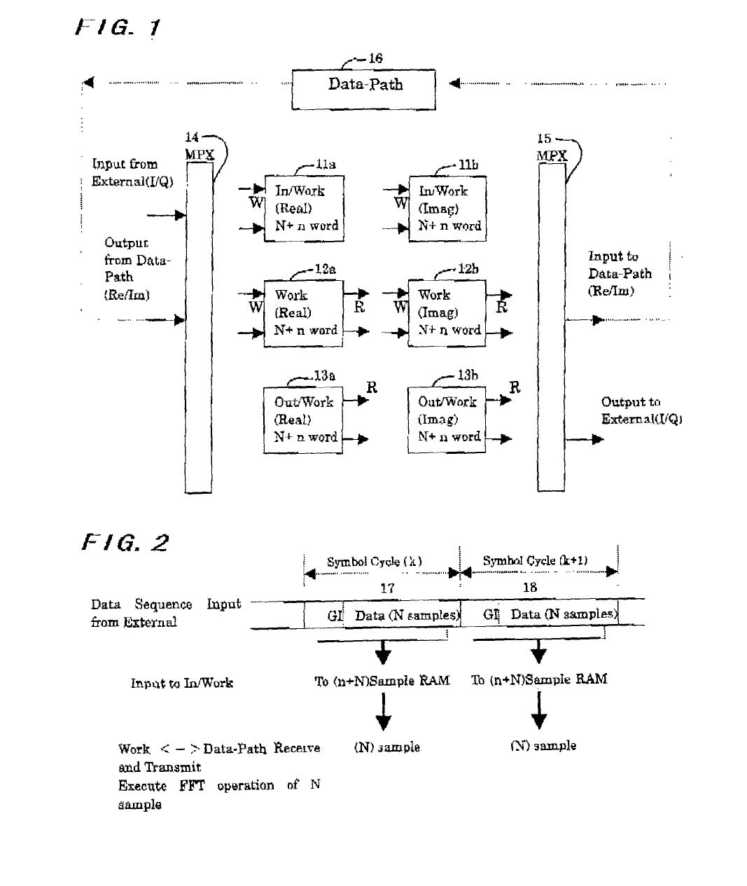

Hereinafter, preferred embodiments of the present invention will be described with reference to the drawings. The first preferred embodiment will be explained by FIGS. 1 and 2. FIG. 1 shows the rough block diagram of the operation circuit with an access timing adaptive control for symbol data in this preferred embodiment.

As shown in FIG. 1, the operation circuit with an access timing adaptive control for symbol data is comprised by memory blocks 11a (a real number part) and 11b (a imaginary number part) that input and store the discrete data sampled at a constant period by sampling, memory blocks for working 12a (a real number part) and 12b (a imaginary number part) that store the intermediate results of the operation or the final computed result, when the operation is executed, memory blocks for outputting 13a (a real number part) and 13b (a imaginary number part) that also execute address transformation concurrently with transmitting the final computed result to the next means. Data-path 16 which execute the FFT operation, multiplexers 14 and 15 for controlling connections between each memory block and Data-path 16, means that input from each memory block and from the Data-path 16, and means which input the data from external and means which output the data to external, and a state control device (not shown) which control the operating sequence of the whole circuit.

The capacity of each of memory blocks 11a, 11b, 12a, 12b, 13a and 13b is allocated to have a size of N+n samples of data. Here, N is data size of one symbol data for FFT operation (N is power of 2) and n is a size smaller than a size of guard interval (GI) at maximum same as the GI length (for example, about as much as n=N/4, N//8, N/16) that is larger than N sampling points required for FFT operation. The reason that all memory blocks have enough capacity to store the N+n sampling points, is because a sequential rotation of the roles of each memory block occurs according to the pipeline operation of the FFT operation, against buffering memory block 11a and 11b for inputting input data from external data sequence, memory block 12a and 12b for working at operation, and buffering memory block 13a and 13b for outputting the computed result, as shown in FIG. 1.

The first embodiment of this invention is characterized in expansion of the size of the memory block (symbol window) for inputting to be able to store N+n samples (N means the size of data and power of 2, n is smaller than GI) using means to input discrete input data sampled at a constant period, and fetch N samples of data from the optimum position.

The progress of operation of this circuit will be explained with referring FIGS. 1 and 2. At the symbol cycle (k) 17, N+n samples of the discrete input data sampled at a constant period is stored from external via an access control function of the multiplexer 14. At the same time, at the Data-path 16, N samples of data of access timing control is read out (fetched) from N+n samples of data that is input to memory blocks 11a and11b at the last symbol cycle. The data is read out from the optimum start address by address control (not shown) of the memory blocks 11a and 11b for improving transmission quality. Then it is transferred to the Data-path 16 via the multiplexer 15 to be executed in FFT operation, and its computed result is stored in the memory blocks 12a and 12b via the multiplexer 14. Also at the above symbol cycle (k) 17, at the memory blocks 13a and 13b, as well as address transformation, an operation that transfer the final computed result of the symbol cycle (k−1) to the next process is concurrently executed.

At next symbol cycle (k+1) 18, as well as the above description, N+n samples of the discrete input data is stored from external to memory blocks 11a and 11b via an access control function of the multiplexer 14. At the same time, at the Data-path 16, N samples of the data of access timing control which is read out from N+n samples of data input to the memory blocks 11a and 11b at the last symbol cycle, is read out from the optimum start address by address control (not shown) of the memory blocks 11a and 11b. Then it is transfer to Data-path 16 through the multiplexer 15 to be operated. and its operating result is stored memory blocks 12a and 12b though the multiplexer 14. At the memory blocks 12a and 12b, as well as address transformation, an operation which transfer the final operating result to next process is concurrently implemented.

The address control for the memory circuit operation can be supported by controlling the offset operation for the start position of read (write) address. The address determination by an address generative circuit of the memory blocks is, specifically, can be implemented by adding the value of the offset address to he start address (address counter information) at a normal situation. A start address can be brought forward from the normal address by executing addition, and can be delayed by executing subtraction. An adder-subtractor can be used as a hard ware. For the amount of the offset of the memory address, for example, it can be adjusted using the information, which is output by the synchronous timing generative device (circuit block) that analyze the symbol window timing information.

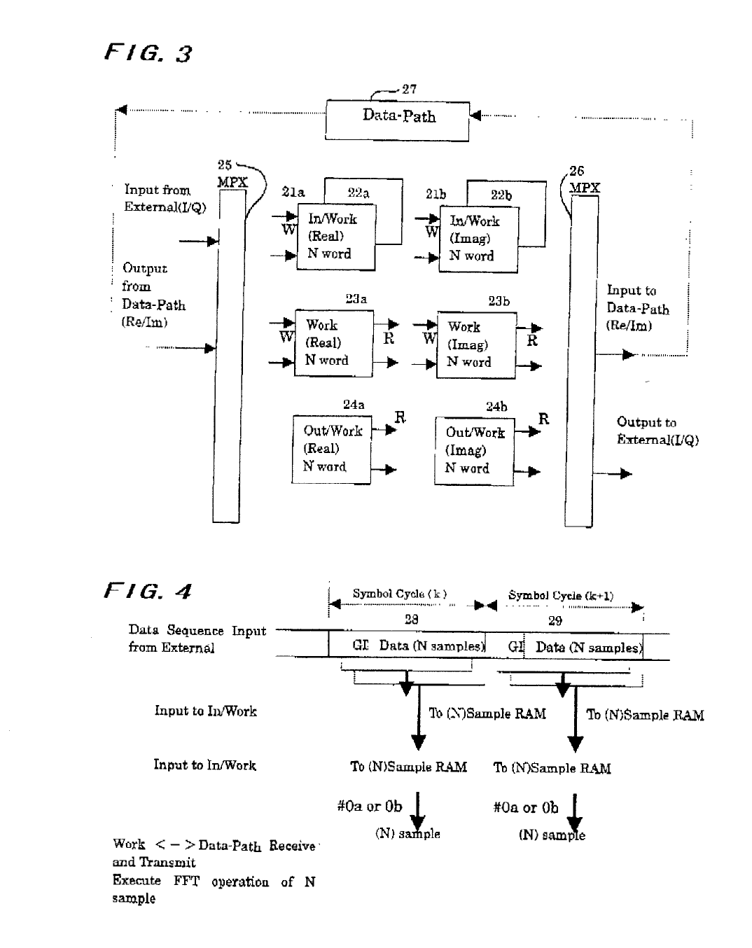

Hereinafter, the second embodiment of the present invention will be described by referring FIGS. 3 and 4. FIG. 3 is a rough functional block diagram of the operation circuit with an access timing adaptive control and FIG. 4 shows its time chart.

As shown in FIG. 3, the operation circuit with an access timing adaptive control is comprised by the memory blocks 21a (a real number part), 21b (an imaginary number part), 22a (a real number part) and 22b (an imaginary number part) which input an store the discrete input data sampled at a constant period, the memory block for working 23a (a real number part) and 23b (an imaginary number part) that store the intermediate results of the operation or the final computed result when an operation is executed, the memory blocks for outputting 24a (a real number part) and 24b (a imaginary number part) that also execute address transformation as they transmit the final computed result to the next process. Data-path 27, for example, which execute FFT operation, multiplexers 25 and 26 that control switching access between each memory block and Data-path 27, data input means from external and data output means to external, and state controlling block (not shown) which control the operation sequence of the whole circuit.

As a feature of the configuration of the memory block, the size for the N samples (N is a size of a symbol data and power of 2) is allocated to the input memory means for inputting 21a, 21b, 22a and 22b that input and store the input data using the discrete input data sampled at a constant period as not changing their size; a configuration that at least 2 blocks of input memory means (one block from each of 21a, 21b, 22a and 22b) for inputting is adopted; and a function is provided to control to select which block of at least 2 blocks of input memory means is fetched independently for FFT operation. The size of the memory block of each of the memory means for inputting 23a and 23b which store the intermediate result or the final computed result that were generated by the specific operation at the operation circuit 27, and the memory means for outputting that has the function to transfer the final computed result of N samples, are made for N (N is power of 2) samples and each memory block is comprised by one block.

FIGS. 3 and 4 show the process of the operation of this circuit. At the Symbol cycle (k) 28, N samples of the discrete input data sampled at a constant period are stored from external via an access control function of the multiplexer 14 in memory blocks 21a, 21b, and also in memory blocks 22a, 22b at a shifted timing to memory blocks 21a, 21b. At the same time, at the Data-path 27, data for N samples is input to the memory blocks 23a and 23b from 2 memory blocks and stored at the last symbol cycle (k−1) is selected. Then the data is transferred to the Data-path 27 for FFT operation and the computed result is transferred and stored to the memory blocks 23a and 23b via the multiplexer 26. Also at the above symbol cycle (k) 28, at the memory block 24a and 24b, as well as address transformation, an operation that transfer the final computed result of the symbol cycle (k−1) to the next process is concurrently performed.

At the symbol cycle (k+1) 29, the discrete input data sampled at a constant period of N samples is stored in memory blocks 21a, 21b, 24a and 24b, via an access control function of the multiplexer 25. At the same time. at the Data-path 27, data of N samples which has been input and stored to the memory blocks 22a and 22b of 2 memory blocks at last symbol cycle (k) 28 is selected. Then the data is transferred to the Data-path 27 and FFT operation is performed, and the computed result is transferred and stored to the memory blocks 23a and 23b via the multiplexer 25. Also at the above symbol cycle (k+1) 29, at the memory blocks 23a and 23b, as well as address transformation, an operation that transfer the final computed result of the symbol cycle (k) to the next step is concurrently implemented.

Different from the first embodiment, in the second embodiment, the size which is made as same sampling point N (power of 2) required for the FFT operation is allocated to each memory block and one more memory block is added for forming input memory block with 2 blocks. Each memory block executes writing operation parallel. Each block of the input memory block execute operation of fetching the data which is shifted by a constant clock cycle from the sample of the common consecutive data sequence. The roles of each memory block which are input buffering for the FFT operation from the data sequence, working buffering for operating process, and output buffering for the computed result rotate according to the pipeline process of the FFT operation. As well as the first embodiment, a timing difference of the data fetching between two blocks can be adjusted by using the information, which is output by tee synchronous timing generative block that analyze memory access timing.

FIG. 5 is a functional block diagram of the address generation circuit for the FFT circuit, according to the present invention. ROM 3-1 generates a pair of address 3-2. This address branches into two address respectively. One of two is address 3-4 that is provided to RAM 3-3, and the other 3-5 is input to logic Circuit 3-6 that is transformed to another address 3-7. As FFT circuits 3-8 and 3-9 have latency, the output of FFT circuit 3-11 is delayed a time after input data 3-10 is given. Register 3-12 holds input address for storing output in the RAM, and generates address data 3-13 that is transformed from the stored address data in this register 3-12, when the output of FFT operation 3-11 is rewritten into RAM 3-3.

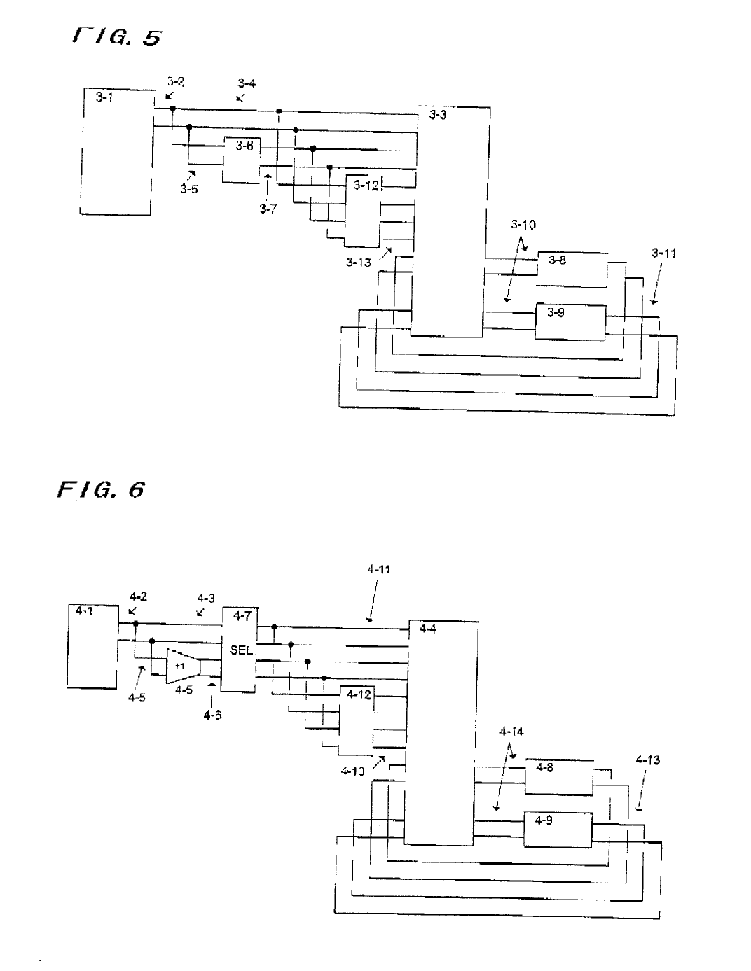

FIG. 6 is a block diagram showing a configuration of the address generation circuit for the FFT operation, according to the first embodiment of the present invention ROM 4-1 generates a pair of address 4-2 for input data. The generated address is branched into two, one address is input to RAM 4-4 directly and the other address is input to an adder 4-5 that is transformed to generate another address 4-6. The operation of the adder is to add one on the input address 4-3 to generate address 4-6, thus the adder can be very small sized and so simple comparing to general adder. Addresses 4-3 and 4-6 are connected to input of selector (controller) 4-7 that selects the address provided to the FFT circuits 4-8 and 4-9. As FFT circuits 4-8 mid 4-9 have latency, the output of FFT circuit 4-14 is delayed a time after input data 4-13 is given Register 4-12 generates address 4-10 that is transformed from the stored address data in this register 4-12, when the output of FFT circuits 4-8 and 4-9 are re-written into RAM 4-4. As FFT circuits 4-8 and 4-9 calculate real part at first and successively calculates imaginary part, FFT circuits 4-8 and 4-9 perform a series of calculations with the same address. It is able to minimize the storage capacity of ROM, since selector 4-7 provides the same address as the previous address to RAM 4-4. Address 4-10 of RAM 4-4 where data is written is stored at the register 4-12 and is delayed a time equal to the latency of FFT circuits 4-8 and 4-9. The register 4-12 provides address 4-11 of RAM 4-4 where data is read. Accordingly it is possible to minimize the storage capacity of ROM. Accordingly, the address generation reduces the memory size of ROM from 8 address * 129 word in the prior art to 2 address * 24 word of present invention.

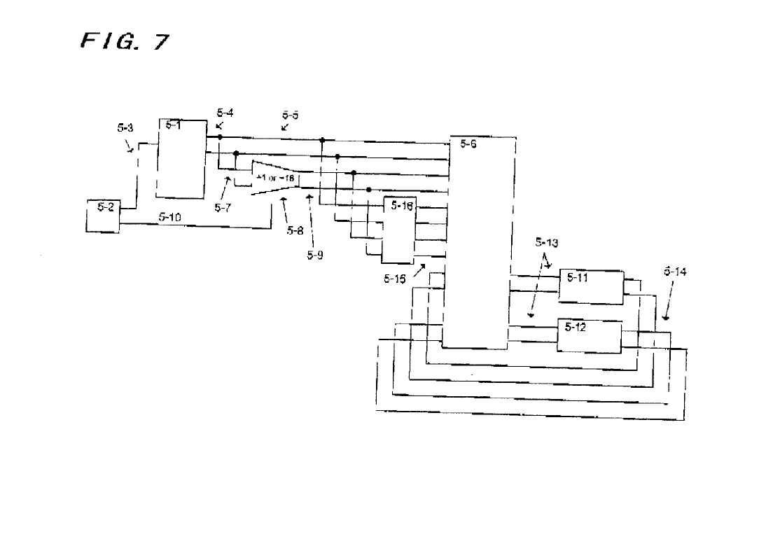

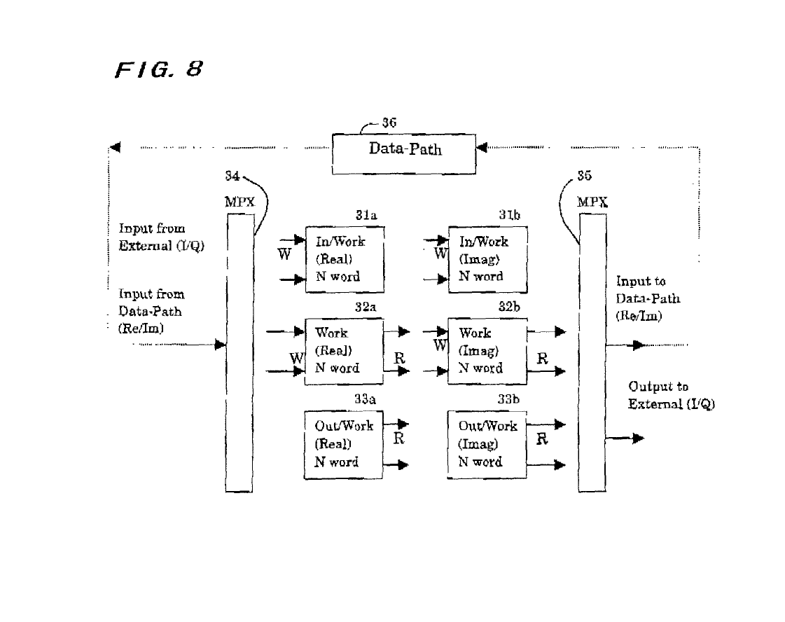

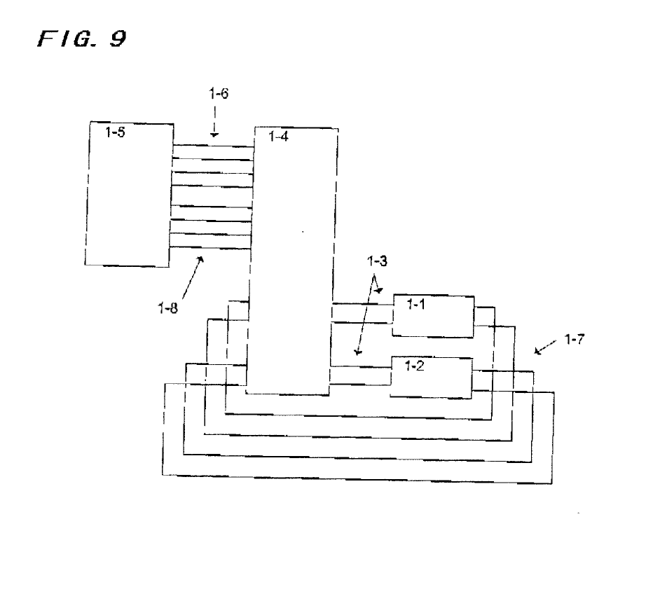

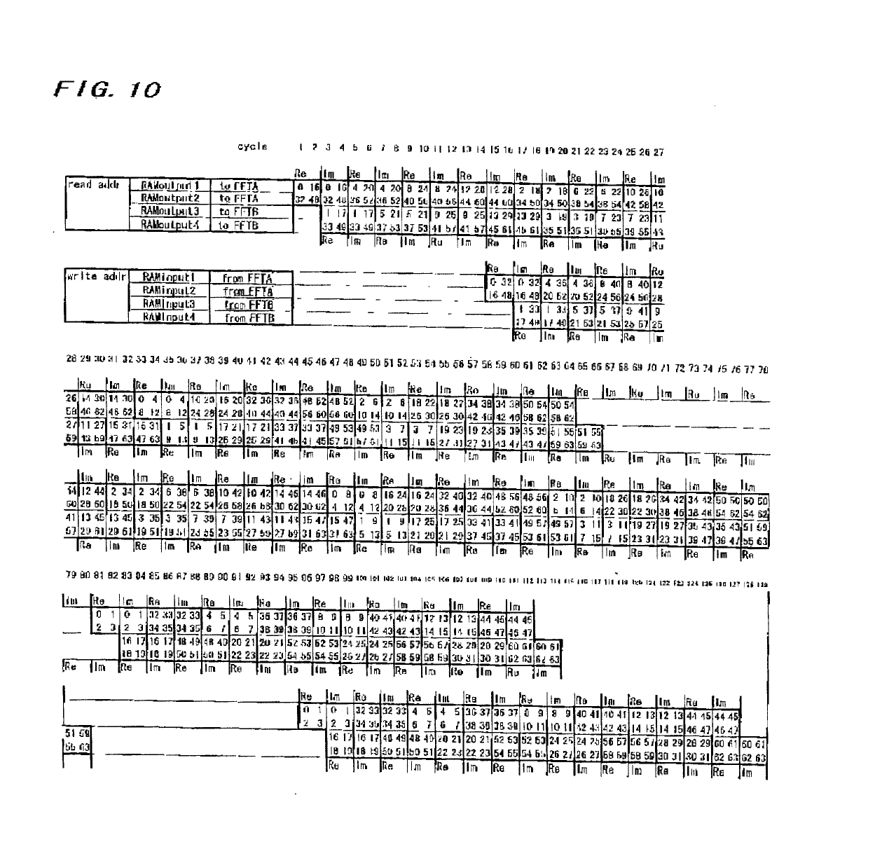

FIG. 7 is a block diagram showing a configuration of the address generation circuit for the FFT circuit, according to the second embodiment of the present invention. By use of the combination of address data shown in FIG. 10, it requires two pairs of addresses twice successively used to perform 64-point, radix 4 butterfly computation. The control circuit 5-2 provides the same address 5-3 twice for ROM 5-1 so as to generate address data twice. The control circuit 5-2 is so simple that it counts up after generating address for ROM 5-1 twice as 0, 1, 01, 2, 3, 2, 3, 4, 5, 4, 5 . . . contrary to as 0, 1, 2, 3, 4, 5 . . . in the prior art.

ROM 5-1 generates one pair of address 3-2. The address is branched into two way respectively. One of two is provided to RAM 5-6 as address 5-5. The other 5-7 is provided to adder 5-6 which transform the address to another address 5-9. The function of the adder is either address 5-7 plus 1 or address 5-7 plus 16. The control circuit 5-2 generates a select signal 5-10 for selecting the function of the adder 5-6. Addresses 5-5 and 5-9 are provided to the RAM 5-6 so that the address of the RAM 5-6 is selected to address 5-13 where the data is stored in FFT circuits 5-11 and 5-12. The address 5-15 for writing a data generated by the FFT circuits 5-11 and 5-12 can be obtained by holding an address, which is used reading the data, in address holding circuit 5-16 for a delayed time of latency of FFT circuit and calling it again. It is also able to reduce the size of storage capacity for ROM.

According to the invention, a simple address generation circuit is provided for performing the butterfly type operation in the FFT circuit, which comprises a combination of small size ROM and simple logic circuit. The use of the combination of ROM and logic circuit reduces the memory size of ROM from {(max number of address generation) * address bit width * an calculation cycles} to {(2 address * 1 address bit width) * (minimum calculation cycles)+simple logic circuit}. Accordingly it is able to reduce the storage size of ROM such that the memory size of ROM can be decreased from 8 address * 129 word in the prior art to 2 address * 24 word in the present invention.

On the OFDM modulation/demodulation system, by adaptive controlling to fetch the position of the discrete input data in the symbol window (time length) from the sequential signal using the periodicity of the discrete sequential signal, a BER performance can be improved and a high-speed and high-quality synchronous reproduction can be obtained.

According to the address generation circuit of the present invention, which comprises a combination of small size ROM and simple logic circuit, it reduce the memory size of ROM from {(max number of address generation) * address bit width * all calculation cycles} to {(2 address * 1 address bit width) * (minimum calculation cycles)+simple logic circuit}.

Although certain preferred embodiments of the present invention have been shown and described in detail, it should be understood that various changes and modifications may be made therein without departing from the scope of the appended claims.

What is claimed is:

1. A symbol window adaptive control operation circuit, comprising:
means for inputting sequentially discrete input data sampled at a constant period;
a memory block for inputting, which stores the input data for N+n samples (N is data size of one symbol data and n is smaller size than GI) from sequentially input data;
an operation circuit with a memory block for working, which executes FFT operation using N samples of data fetched from said input data stored in the memory block for inputting, and said memory block for working stores intermediate result of the operation or final computed result for N+n samples;
a memory block for outputting, which store final computed result for N+n samples,
multiplexers, which connect and switch connection between output/input of each of memory blocks for inputting, working, and outputting, and output/input of the operation circuit; and
a control block for controlling operation sequences of above memory blocks, operation circuit, and multiplexers.

2. A symbol window adaptive control operation circuit according to claim 1, wherein roles and functions of each of the above memory blocks for inputting, working and outputting, move by rotation according to movement of N samples of data that are alternately input/output and operated following time sequence.

3. A symbol window adaptive control operation circuit, comprising:
means for inputting sequentially discrete input data sampled at a constant period;
memory blocks for inputting, which store the input data for N samples (N is data size of one symbol data) with at least two blocks which store the above input data as different timing each other from sequentially input data;
an operation circuit with a memory block for working, which executes FFT operation using N samples of data fetched from one of said at least two memory blocks for inputting, and said memory block for working stores intermediate result of the operation or final computed result for N samples;
a memory block for outputting, which store final computed result for N+n samples;
multiplexers, which connect and switch connection between output/input of each of memory blocks for inputting, working, and outputting, and output/input of the operation circuit; and
a control block for controlling operation sequences of above memory blocks, operation circuit, and multiplexers.

4. A symbol window adaptive control operation circuit according to claim 3, wherein more than three blocks of memory block for inputting is provided, and store the input data for N samples with different timing each other from sequentially input data.

5. A symbol window adaptive control operation circuit according to claim 3, wherein roles and functions of each of the above memory blocks for inputting, working and outputting, move by rotation according to movement of N samples of data that are alternately input/output and operated following time sequence.

6. An address generation circuit for controlling sequence of input data, which is processed by butterfly computation operation in FFT circuit, comprising:
a ROM for generating a pair of address, said pair of address being branched into two, one of said branched address is input to data memory means and address holding means, another of said branched address is input to logic circuit;
an output of said logic circuit being branched into two, one of said branched address being input to said data memory means, and another of said branched address being input to said address holding means; and
an output of said address holding means being input to said data memory means.
